(19) United States
(12) Patent Application Publication
(10) Pub. No.: US 2005/0004308 A1
(43) Pub. Date: Jan. 6, 2005

(54) Polyamide and polyvinylbutyral compositions and blends having enhanced surface properties and articles made therefrom

(76) Inventors: Win-Chung Lee, Parkersburg, WV (US); I-Chung W. Wang, Vienna, WV (US); Gloria J. Jones, Washington, WV (US); Bert C. Wong, Hockessin, DE (US); Paul P. Cheng, Washington, WV (US); Daniel J. McKiernan, Parkersburg, WV (US); Charles J. Refshauge, Washington, WV (US); Yong Yu, Rochester, MI (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/799,057

(22) Filed: Mar. 12, 2004

Related U.S. Application Data
(60) Provisional application No. 60/454,890, filed on Mar. 14, 2003.

(51) Int. Cl. C08L 27/00; C08L 83/00; C08F 8/00

(52) U.S. Cl. 525/100; 525/104; 525/106

(57) ABSTRACT

Polyamide compositions and blends toughened with polyvinylbutyral having enhanced adhesive surface properties are disclosed, together with articles of manufacture.

This application claims the benefit of U.S. Provisional Application No. 60/454,890, filed Mar. 14, 2003.

### FIELD OF THE INVENTION

The present invention relates to polyamide blends with polyvinylbutyral (PVB). More particularly, the present invention relates to such blends, processes for the manufacture of such materials, and molded articles prepared therefrom.

### BACKGROUND OF THE INVENTION

It is well known that toughening agents such as grafted rubbers can be employed to improve the toughness of polyamides. See generally, U.S. Pat. No. 4,174,358. It is also well known that glass fibers can be incorporated into such polyamide blends to increase their stiffness. Such a product has been available from E.I. DuPont de Nemours and Company (DuPont) for a number of years, under the name ZYTEL® 80G33HS1L BK104. It is also well known that plasticized polyvinylbutyral (PVB) can be used as a toughener in, for example, 6-nylon. See generally, U.S. Pat. No. 5,770,654 which is directed to such compositions suitable for a variety of applications where good toughness is required, as in packaging subjected to rough handling. As used herein polyvinylbutyral is abbreviated as “PVB”.

Plasticized PVB can be difficult to handle as a feed to a compounding extruder due to its inherent stickiness. Similarly PVB sheet is a material that can be difficult to work with because of the tendency to adhere to itself. Sheets of PVB can stick together, or bind, with such strength that it is very difficult to separate the layers. The irreversible nature of this self-adhesion by PVB is referred to in the art of PVB manufacture as “blocking”. Once PVB “blocks”, process difficulties are encountered. This tendency to block can make manufacturing processes that incorporate PVB complex and difficult. Consequently, continuous processes in which PVB is handled either in sheet form or in small shredded pieces can be very expensive to run, and therefore are not practical.

Moreover, blends of PVB sheet or small shredded pieces with other materials can block in the same manner as homogenous PVB compositions. Such blends of PVB with other polymers can be difficult to obtain in a cost-effective manner. A preferred process for preparing blends of PVB with other polymers would utilize conventional loss-in-weight screw feeders, which are found throughout that industry.

Recent work in the field indicates that blends of PVB with polyethylene and grafted rubbers are sufficiently non-sticky that they can be fed into a compounding extruder. See for example, WO 02/12356 directed to a process for preparing pellets from PVB scrap material.

It is an object of the present invention to provide PVB-toughened polyamide compositions having enhanced surface adhesion, making them suitable for use in a variety of applications.

### SUMMARY OF THE INVENTION

In one aspect, the present invention is a polyamide composition having enhanced surface adhesion properties, comprising: the reaction product of a silane coupling compound and a polyamide blend.

In another aspect, the present invention is a thermoplastic polyamide composition comprising: (a) from about 5 to about 30 weight percent of a free-flowing toughener comprising from about 20 weight percent to about 95 weight percent polyvinyl butyral; (b) complimentally, 95 to 25 weight percent polyamide that is melt processible below about 320° C. and a number average molecular weight of at least 5,000; (c) a coupling agent; and (d) optionally, a filler in an amount of up to about 45 weight percent.

In still another aspect, the present invention is a process for enhancing the surface adhesion of a polyamide blend comprising the step: coating a surface of the polyamide blend with a silane coupling agent.

### DETAILED DESCRIPTION OF THE INVENTION

In one embodiment, the present invention is a thermoplastic polyamide composition having enhanced surface adhesion properties. Enhanced surface adhesion in a polyamide of the present invention is determined relative to conventional polyamide compositions. A polyamide composition of the present invention is preferably a blend of a polyamide with at least one other polymer. The polyamide composition of the present invention can comprise, in addition to the polyamide, an adhesion-promoting polymer. In one embodiment the polyamide is preferably a blended composition of a polyamide with at least one thermoplastic polymer such as is described in U.S. Pat. No. 4,174,358. Such blends are commercially available from DuPont under the trade name Zytel®, for example, or alternatively a polyamide/PVB blend such as is described hereinbelow.

Polyamide blends suitable for use in the practice of the present invention are blends of conventional polyamides such as: Nylon 6; Nylon 66; Nylon 69; Nylon 610; and Nylon 612; Nylon 11; Nylon 12; Nylon 12, 12; and copolymers of epsilon-caprolactam with hexamethylenediamine and adipic acid for example, with at least one polymer of the type described in U.S. Pat. No. 4,174,358. For example, suitable polyamides, as described in U.S. Pat. No. 4,174,358, can be blended with thermoplastic or elastomeric polymers as tougheners such as polyolefins, ethylene copolymers, grafted polymers and copolymers such as maleic anhydride grafted ethylene copolymers, and similar polymers or mixtures thereof. A more complete list of suitable elastomeric or thermoplastic polymers can be found in the above-referenced U.S. patent. The blends can comprise from about 1 to about 99 wt % of the polyamide, preferably from about 60 to about 99 wt %, and more preferably from about 80 to about 95 wt % polyamide, by weight of the total composition.

The polyamide blend can comprise on its surface, or incorporated within the polymer matrix, an adhesion-promoting compound. Preferably, the adhesion promoting compound is a silane coupling compound, as described further hereinbelow.

In a preferred embodiment, the present invention is a toughened polyamide composition having enhanced surface adhesion properties with or without use of a coupling compound. A composition of the present invention comprises a free-flowing PVB composition as a toughener, as described in WO 0212356, incorporated herein by reference. A composition of the present invention comprises from about 5 wt % to about 30 wt %, preferably from about 5 wt % to about 28 wt %, more preferably from about 6 wt % to about 25 wt %, and most preferably from about 7 wt % to about 25 wt % of a free-flowing PVB composition. The toughener comprises from about 20 to about 95 wt %, preferably from about 40 wt % to about 95 wt %, more preferably from about 60 wt % to about 95 wt %, and most preferably from about 75 wt % to about 95 wt % PVB. The compositions and blends of this invention can be prepared by mixing or blending a free-flowing toughener with nylon, an optional coupling agent, and other ingredients to produce a toughened polyamide blend having enhanced surface properties.

The toughener comprises at least one component in addition to the PVB. Such other components can be monomeric or polymeric materials, or mixtures thereof. The other components can be selected from polymers and/or monomers that have reactive functionality, or non-reactive polymer and/or monomers such as, for example, polyethylene, polypropylene, polyvinylchloride, nylon, other thermoplastic materials, or mixtures thereof. Preferably the second component is a polymer composition that includes reactive functionality such as anhydride functionality, such as is available commercially from E. I. DuPont de Nemours and Company under the Fusabond® brand name, or carboxylic acid functionality. Fusabond® polymers are polyolefins having anhydride functionality. The other components are present in the toughener in amounts that are complimentary to the amount of PVB in the toughener, that is to bring the total percentage of PVB and other component(s) to 100 wt %.

The polyamide with which the toughener is blended can be any amorphous or crystalline polyamide as described in U.S. Pat. No. 5,770,654, for example, or in U.S. Pat. No. 4,174,358. Preferably, the polyamide is melt processible below a temperature of about 320° C. and has a number average molecular weight of at least 5,000. The polyamide component can be present in an amount of from about 25 wt % to about 95 wt %. Preferably, the polyamide component is present in an amount of from about 30 wt % to about 90 wt %, more preferably from about 40 wt % to about 90 wt %, most preferably from about 50 wt % to about 90 wt %.

Fillers can optionally be present in an amount of from about 0 to about 45 wt %. If included, fillers are preferably present in an amount of from about 1 wt % to about 45 wt %. Suitable fillers are, for example, calcined clay, metal carbonates, titanium dioxide, wollastonite, glass, or talc. Glass-filled compositions can include glass from any number of sources, or in any form. For example, glass can be included in crushed form, as shards, as particulate glass, as fiber, or any other form that glass can be included and processed using the process described herein.

As noted hereinabove a coupling agent can optionally be used in the composition of the present invention. The coupling agent can further enhance the adhesive surface properties of the toughened polyamide compositions of the present invention. The coupling agent can be a silane compound. Preferably the coupling compound is selected from the group consisting of: gamma-aminopropyltrimethoxysilane; gamma-aminopropyltriethoxysilane; N-2-aminopropyltrialkoxysilane; or N-(2-aminoethyl)-3-aminopropylmethyldialkoxysilane. The coupling compound can be present in an amount of at least about 0.01 wt %. Preferably, the coupling agent is present in an amount of from about 0.1 to about 3 wt %. More preferably, the coupling agent is present in an amount of from about 0.3 wt % to about 2.0 wt %, and most preferably in an amount of from about 0.5 wt % to about 1.5 wt %.

An antioxidant is not required, however an antioxidant can be preferred. If included, the antioxidant can be present in an amount of at least about 0.1% by weight, and up to an amount where the effect of the antioxidant is optimal.

In another embodiment, the present invention is a process for preparing polyamide compositions of the present invention having enhanced adhesion. The polyamide of the present invention can be obtained by blending a suitable polyamide with PVB, for example Ecocite™.

Alternatively, polyamides having enhanced adhesive properties are obtained by further incorporating a coupling or crosslinking agent with the toughened polyamide or a suitable polyamide blend. For example, a silane coupling agent can be incorporated by either inclusion into the bulk of the polyamide composition, or by coating the surface of the polyamide composition. The coupling compound can be incorporated in either manner as an aqueous solution. The pH of the solution can be lowered using an acid such as acetic acid or citric acid, for example.

In a preferred embodiment, the present invention is a process wherein plasticized PVB and three other ingredients (a reactive polymer such as Fusabond®, a non-reactive polymer such as polyethylene, polypropylene, or ethylene/n-butyl, and an antioxidant) are made into pellets and subsequently combined with a polyamide to provide the toughened polyamide compositions of the present invention.

The toughener can be prepared prior to addition to the polyamide, for example, by mixing the components at an elevated temperature in the range of from about 100° C. to about 280° C., preferably from about 150° C. to about 220° C. to provide a homogeneous melt blend. The blend obtained from the mixing procedure can be transferred by some means to a set of roll mills for additional mixing and to press the blend into a sheet form. A strip of the sheet can be fed either continuously or by a batch process to an extruder, but preferably the sheet is continuously fed using, for example, a belt feeder. Once inside the extruder, the sheet is melted and the melt is filtered to remove solid contamination. The polymer can be pelletized by any known or conventional method. For example, the filtered melt can be distributed to a die wherein the die has multiple holes. In such a process the melt exits the die at the die face, which can be positioned just above the surface of the water in a tank filled with water, or submerged under the surface of the water to quickly cool (quench) the melt as it exits the die. An under water face cutter can be used to cut the polymer exiting the die face to form pellets. The water quenches the pellets and carries them to a filter screen to separate them from the bulk water. The wet pellets can be dried, for example in a fluidized dryer, before they are packed.

The pellets thus obtained can be mixed by melt blending with suitable polyamide compositions, as described in U.S. Pat. No 5,770,654, herein incorporated by reference. For example, the toughened polyamide blends of the present invention can be obtained by melt blending, or melt mixing in any suitable blending or mixing device, such as a Banbury blenders, Haake mixers, Farrell mixers, or extruders. Extruders can be either single screw or twin screw extruders with screws having various degrees of severity. Mixing or blending can be done at a temperature in the range of from about 200° C. to about 320° C., and preferably at a temperature in the range of from about 230° C. to about 300° C. The blends can be palletized by any known conventional method. Preferably pellets are formed by cutting extruded strands of the blend.

Still alternatively, a suitable polyamide composition can be obtained by a process comprising the step of blending a free-flowing PVB composition, such as Ecocite™ with a polyamide.

In another embodiment, the present invention is an article obtained from the polyamide compositions of the present invention. Articles of the present invention include laminate articles, shaped articles, etc. Laminates comprising the polyamide compositions of the present invention can be incorporated into various other articles such as, for example, cars, trains, automobiles, appliances, boats, acoustic tiles, acoustic flooring, walls, ceilings, roofing materials or other articles where sound damping and/or tough polymers are desirable.

Unlike conventional PVB products, the polyamide compositions of the present invention are not fully transparent and therefore are not suitable for use in glazing, in automobile windshields, or similar applications where transparency is an important factor. However, the toughened polyamide compositions of the present invention have enhanced impact performance, as indicated by Notched Izod tests. As such, the polyamide compositions of the present invention can be used to produce articles that can be used in applications requiring tough polymeric structural components.

The enhanced adhesive properties of the polyamides of the present invention make the polyamides of the present invention suitable for use in laminate articles. In a particularly preferred embodiment, polyamide compositions of the present invention can be laminated to other polymeric materials, such as thermoplastic elastomers (TPEs), conventional PVB, polyurethane, polyvinylchloride, polycarbonate, or other polyamides.

TPEs are thermoplastic materials that have rubber-like properties and are polymers which are soft to the touch. However, TPEs do not generally have good adhesion to rigid polymers. TPE laminates with polyamides of the present invention can reduce or eliminate this adhesion problem in many cases. Such multilayer constructions of TPE's with the polyamides of the present invention can find use in automobile interiors, buttons or switches on electronic equipment or electronic devices such as stereos, compact disc players, telephones, television sets, remote controls, computers, keypads, touch-screens, for example.

In another preferred embodiment, the polyamide compositions of the present invention can be laminated with PVB to yield PVB laminates having substantial sound reduction properties. Sound reducing panels can find use in many applications, including use in construction materials, appliance panels, automobile panels, highway sound barriers, walls, ceilings, and floors, for example.

In a particularly preferred embodiment, a single sheet of PVB can be laminated between two polyamide sheets of the present invention. Laminates having at least two sheets of the polyamide of the present invention adhered on opposite surfaces of a PVB polymer sheet can demonstrate improved structural strength compared to one sheet of the polyamide having twice the thickness of one of the laminated polyamide sheets. Such laminates can find use in car door panels, boat hulls, or other similar uses to impart structure, strength, and noise reduction. Lamination of the sheets can be by conventional methods, such as coextrusion, press molding, or injection molding. The laminates can be hard panels or soft sheets for use in a variety of applications.

In still another embodiment the polyamide compositions of the present invention can be used as an adhesive layer or film for the purpose of binding glass fibers that are on or near the surface of articles comprising fiber-glass filled polyamide compositions. Glass-filled polyamide compositions can have problems which result from loss of adhesion between the polyamide and the glass fibers on or near the surface of the glass-filled polyamide composition. This can in turn lead to shedding of glass fibers and loss of same to the surrounding environment, or unwanted transfer of glass fibers to other articles or people. A glass-filled polyamide composition of the present invention can demonstrate improved adhesion to glass fibers at or near the surface, and therefore can reduce the occurrences of problems associated with loss of adhesion between glass fibers and glass-filled polyamide compositions.

### EXAMPLES

### Examples E1 & E2 and Comparative Example C1

Extrusion Process to Produce Polymer Blends

ECOCITE™, commercially available from DuPont, was melt blended together with nylon-6 (Ultramid® B-3, available commercially from BASF Corp.). The comparative example C1 included no Ecocite™, but instead included a mixture of conventional tougheners (T-mix) at 15 wt %. During the operation for melt blending the ingredients were charged to the blender using individually controlled loss in weight feeders. The mixture was compounded by melt blending in a 40 mm Werner & Pfleiderer co-rotating twin screw extruder with a barrel temperature about 240° C. and a die temperature of about 260° C. All of the ingredients were fed into the first barrel section. Extrusion was carried out with a port under vacuum. The screw speed was 250 rpm and the total extruder feed rate was 150 pounds per hour.

The resulting strand was quenched in water, cut into pellets, and sparged with nitrogen until cool. The moisture in the resulting pellets was adjusted to between 0.1% and 0.2% by drying or adding additional water as required.

Modified Compressive Shear Stress (CSS) Test for Adhesion of Laminated Polymer Plate

Plagues of 5×5 inch with 2 mm thickness were molded in an injection molding machine according to ISO 294. Stiff PVB (that is, PVB having less than 30 pph of plasticizer) was sandwiched between two plagues in a humidity controlled room. After being autoclaved at 135° C. for 20 minutes, the 5×5 inch laminated polymer plate was cut to obtain six 1×1 inch squares from the center plate. Each square was sheared at 45 degree angle in an Instron in a humidity controlled room. Force (pounds per inch) required to shear the square apart (CSS) was measured and recorded. The average force (Avg) and the standard deviation was calculated for each sample and recorded in Table 1. The amount of ECOCITE™ Grade H used in Examples 1 and 2 (E1 & E2) was varied. For comparative example 1 (C1), a mixture (T-mix) of conventional tougheners—Fusabond® (available from DuPont) and Engage® (available from DuPont-Dow Elastomers) was included.

TABLE 1

| Example # | Additive (Wt %) | CSS Avg (Std. Dev) |
|---|---|---|
| C1 | T-mix (15) | 1345.318 (360.322) |
| E1 | ECOCITE ™ H (15) | 1859.696 (156.49) |
| E2 | ECOCITE ™ H (25) | 1736.568 (214.004) |

Replacing the conventional tougheners with ECOCITE™ H resulted in increased adhesion in the laminated polymer plates.

### Examples E3 to E11

The same process and procedures in above Examples E1, E2, & C1 were used for Examples E3 to E11 in Table 2 except that the Stiff PVB was coated with Silquest A-1100® using each of three coating methods before being dried and laminated:
Coating Method 1—3% Silquest® A-1100 aqueous solution at pH 7
Coating Method 2—3% Silquest® A-1100 aqueous solution at pH 4.0 with Acetic Acid

Coating Method 3—3% Silquest® A-1100 aqueous solution at pH 3.0 with Citric Acid

TABLE 2
Improved Adhesion on Nylon 6 Blends with Silane
Coating

| Example # | Additive (Wt %) | Method | CSS Avg (Std. Dev) |
|---|---|---|---|
| E3 | T-mix (15) | 1 | 2210.537 (54.441) |
| E4 | ECOCITE ™ H (15) | 1 | 1820.596 (578.155) |
| E5 | ECOCITE ™ H (25) | 1 | 1799.268 (411.985) |
| E6 | T-mix (15) | 2 | 2161.352 (108.387) |
| E7 | ECOCITE ™ H (15) | 2 | 2536.738 (77.387) |
| E8 | ECOCITE ™ H (25) | 2 | 2344.607 (73.163) |
| E9 | T-mix (15) | 3 | 2221.338 (71.298) |
| E10 | ECOCITE ™ H (15) | 3 | 2476.787 (132.555) |
| E11 | ECOCITE ™ H (25) | 3 | 2303.907 (58.886) |

The adhesion was increased by addition of Silquest® A-1100 in each of the three different ways.

### Examples E12 to E15 & C2

The same process and procedures in above Examples E1, E2, & C1 were used for Examples E12 to E15 & C2 in Table 3 except 33 wt % glass fiber (PPG 3660, available commercially from PPG Industries) was fed into the sixth barrel section of the extruder by use of a side feeder. Adhesion results are reported in Table 3.

TABLE 3

| Example # | Additive (Wt %) | CSS Avg (Std. Dev) |
|---|---|---|
| C2 | T-mix (13) | 871.371 (281.556) |
| E12^{a} | ECOCTTE ™ E (13) | 2005.93 (292.506) |
| E13^{a} | ECOCITE ™ G (13) | 2664.57 (149.503) |
| E14^{a} | ECOCITE ™ H (13) | 2637.45 (137.638) |
| E15^{b} | ECOCITE ™ H (10.5) | 2603.35 (179.75) |

^{a}natural color glass-filled nylon 6
^{b}black glass-filled nylon 6

Replacing conventional tougheners with ECOCITE™ Grade E, G, or H resulted in increased adhesion in the laminated polymer plates as E12 to E15 are compared to C2.

### Examples E16 to E18 and C3

The same process and procedures in above Examples E12 to E14, & C2 were used for Examples E16 to E18 and C3 in Table 4 except that stiff PVB was replaced by “standard” Butacite® B140C, available from DuPont. Adhesion results are reported in Table 4.

TABLE 4

| Example # | Additive (13 Wt %) | CSS Avg (Std. Dev) |
|---|---|---|
| C3 | T-mix | 764.1 (100.1) |
| E16 | ECOCITE ™ E | 1130.3 (59.9) |
| E17 | ECOCITE ™ G | 1140.6 (161.7) |
| E18 | ECOCITE ™ H | 1120.3 (65.6) |

Replacing conventional tougheners with ECOCITE™ Grade E, G, or H resulted in increased adhesion in the laminated polymer plates as E16 to E18 are compared to C3.

### Examples E19 to E24

The same process and procedures in above Examples E18, & C3 were used for Examples E19 to E24 in Table 5 except standard Butacite® B140C was used in place of stiff PVB and coated with Silquest® A-1100 using each of three coating methods:
Coating Method 1—3% Silquest® A-1100 aqueous solution at pH 7
Coating Method 2—3% Silquest® A-1100 aqueous solution at pH 4.0 with Acetic Acid
Coating Method 3—3% Silquest® A-1100 aqueous solution at pH 3.0 with Citric Acid

The results are reported in Table 5.

TABLE 5
Improved Adhesion on Glass Filled Nylon 6 Blends with
Silane Coating on Standard Butacite ®

| Example # | Additive (13 Wt %) | Method | CSS Avg (Std. Dev) |
|---|---|---|---|
| E19 | T-mix | 1 | 916.472 (165.416) |
| E20 | ECOCITE ™ H | 1 | 1282.85 (306.367) |
| E21 | T-mix | 2 | 1499.83 (104.3) |
| E22 | ECOCITE ™ H | 2 | 1934.7 (305.721) |
| E23 | T-mix | 3 | 1580.22 (128.283) |
| E24 | ECOCITE ™ H | 3 | 2227.3 (279.978) |

The adhesion was increased by addition of Silane in each of the three different coating methods.

### Examples E25, E26, C5 & C6

Using stiff PVB, the same process and procedures in above Examples E1, E2, & C1 were used for Examples E25, E26, & C6 in Table 6 except Nylon 6 was replaced by Zytel® 101 (available commercially from E.I. DuPont de Nemours and Company) and 40 wt % mineral (Translink HF900, available commercially from Englehard) was fed into the sixth barrel section of the extruder by use of a side feeder. Temperatures for extruder barrel and die were increased to about 280° C. and 290° C., respectively. Zytel® 11C40, commercially available from DuPont, was used to make the laminated plate in Control example C5. Adhesion results are reported in Table 6.

TABLE 6
Effect of ECOCITE ™ on Mineral Filled Nylon 66

| Example # | Additive (Wt %) | CSS Avg (Std. Dev) |
|---|---|---|
| C5 | Zytel ® 11C40 | 1445.4 (213.27) |
| C6 | FA^{a} (9) | 1088.5 (226.48) |
| E25 | ECOCITE ™ H (18) | 2095.1 (84.29) |
| E26 | ECOCITE ™ H (9) + FA (9) | 2297.9 (240.1) |

^{a}Fusabond ® A MG-423D

The adhesion was increased by addition of ECOCITE™ H.

### Examples E27 to E38

The same process and procedures in above Examples E25, E26, C5, & C6 were used for Examples E27 to E38 in Table 7 except Stiff PVB was coated with Silane such as Silquest® A-1100 in three ways before being dried and laminated:
Coating Method 1—3% Silquest® A-1100 aqueous solution at pH 7
Coating Method 2—3% Silquest® A-1100 aqueous solution at pH 4.0 with Acetic Acid
Coating Method 3—3% Silquest® A-1100 aqueous solution at pH 3.0 with Citric Acid

The results are reported in Table 7.

TABLE 7
Improved Adhesion on Mineral Filled Nylon 6 Blends

| Example # | Additive (Wt %) | Method | CSS Avg (Std. ev) |
|---|---|---|---|
| E27^{a} | Zytel ® 11C40 | 1 | 3334.7 (252.27) |
| E28 | FA^{b} (9) | 1 | 2597.1 (52.81) |
| E29 | ECOCITE ™ H (18) | 1 | 2480 (154.42) |
| E30 | ECOCITE ™ H (9) + FA (9) | 1 | 2491.2 (90.1) |
| E31^{a} | Zytel ® 11C40 | 2 | 2843.1 (148.18) |
| E32 | FA (9) | 2 | 2291.8 (186.42) |
| E33 | ECOCITE ™ H (18) | 2 | 2327.2 (154.51) |
| E34 | ECOCITE ™ H (9) + FA (9) | 2 | 2272.4 (216.95) |
| E35^{a} | zytel ® 11C40 | 3 | 2879.8 (124.33) |
| E36 | FA (9) | 3 | 2293.3 (109.65) |
| E37 | ECOCITE ™ H (18) | 3 | 2074.5 (138.71) |
| E38 | ECOCITE ™ H (9) + FA (9) | 3 | 2476.4 (135.71) |

^{a}Sample is 100% Zytel 11C40, commercially available from Dupont
^{b}Fusabond ® A MG-423D

Comparing Examples E27 to E38 versus Examples E25, E26, C5, & C6, respectively, the adhesion was increased by addition of Silquest® A-1100 by all methods.

### Examples E39 to E44

Enhanced Adhesion Through Extruder Silane Addition for Mineral Filled Nylon 66

The same process and procedures in above Examples E25, E26, & C6 were used for Examples E39 to E44 with stiff PVB in Table 8 except Silane such as Silquest A-1100® was mixed with the Zytel® 101 before feeding to the extruder. Adhesion results are reported in Table 8.

TABLE 8
Improved Adhesion on Mineral Filled Nylon 6 Blends
with Silane Addition^{a} to Polymer in the Extruder

| Example # | Additive (Wt %) | CSS Avg (Std. Dev) |
|---|---|---|
| E39 | ECOCITE ™ H (9) + Si | 3247.8 (77.384) |
| E40 | ECOCITE ™ H (12) + Si | 3369.8 (260.443) |
| E41 | ECOCITE ™ H (18) + Si | 3384.5 (298.798) |
| E42 | ECOCITE ™ H (9) + FA (9) + Si | 2938.5 (92.315) |
| E43 | FA^{b} (9) + Si | 2820.7 (181.175) |
| E44 | FC^{c} (9) + Si | 2760.9 (208.301) |

^{a}The Silane compound is present at a level of less than 0.5 wt % in each sample.
^{b}Fusabond ® A MG-423D
^{c}Fusabond ® C MC190D (commercially from E.I. DuPont de Nemours and Company.

The adhesion was increased by addition of Silquest® A-1100 in the extruder.

SEM (Scanning Electronic Microscopy) Pictures of Example E15

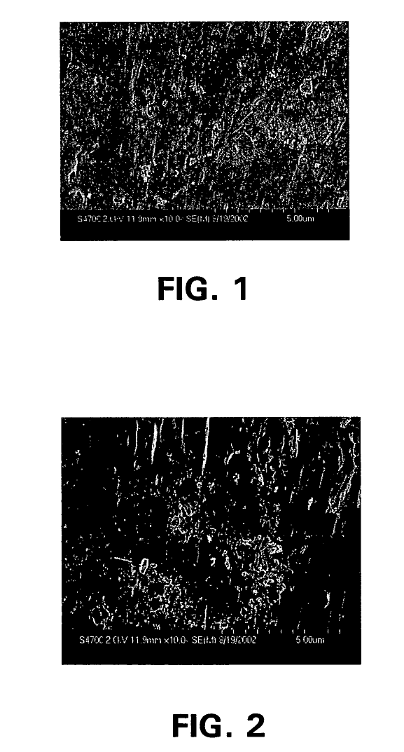

The PVB particles dispersed on the polymer surface were shown as the tiny holes in the following two FIG. 1 and FIG. 2. The tensile bar of Example E15 was extracted with methanol to remove surface PVB. SEM pictures were taken on two arbitrary surfaces after methanol extraction.

### Examples E45 to 56 and Control Examples C7 to C10

Sound Reduction Results for Laminated Glass Filled Nylon 6 Round Disc.

The same process and procedures in above Examples E12 to E14, & C2 were used for Examples E45 to E56 & C7 to C10 in Table 9 except round discs of 4 inch diameter with 2 mm thickness were molded in an injection molding machine. Three types of PVB sheeting were used as the interlayer to make laminated polymer discs:
1. Stiff PVB (less than 30 pph plasticizer)
2. Standard Butacite® B140C
3. Special PVB (43% plasticizer)
   Those laminated polymer discs were used in a sound reduction test unit as described in the following.
   Sound Reduction Test

Sound intensity was measured from 12.5 to 10,000 Hz (Hertz) frequency at 12.5 Hz increments. Duplicate results were recorded for the incoming sound (S), that is the sound prior to attenuation by the laminate. The sound intensity passing through a laminated polymer plate (S*) was also recorded. The absorption intensity or the sound power level loss (SPLL) in dB at each frequency was calculated according to the following equation:
SPLL=20*LOG₁₀(S*/S_{Avg}),
wherein S_{Avg} is the average of two incoming sound measurements.
The sum of all frequencies are recorded in Table 9 under the column heading “Total Sound Reduction in dB.”

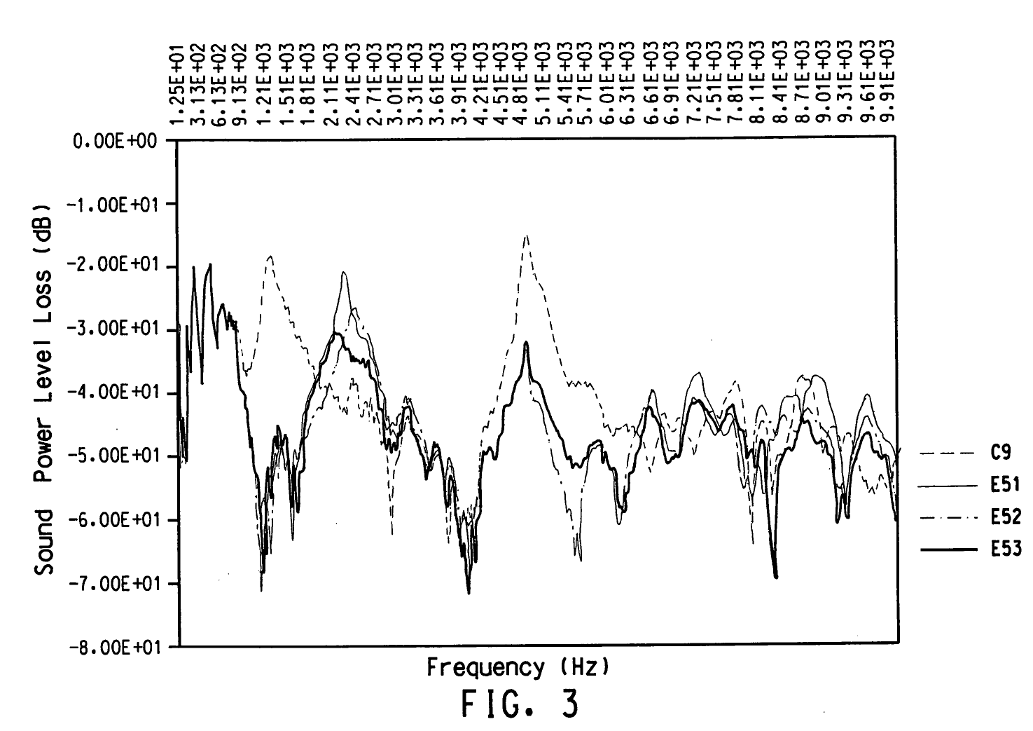

For the above Sound Reduction Test, laminated polymer discs were used for E45 to E56, while two non-laminated discs were used for the control examples. The difference in total sound reduction for a laminated disc versus the control with two non-laminated discs was also recorded in Table 9 under column heading “dB Reduction versus Control.” The sound power level loss in dB was also plotted versus sound frequency as shown in FIG. 3 for C9, E51. E52, & E53. The sound reduction is much better for laminated polymer discs than the polymer without lamination, especially in the frequency ranges of 1000 to 2000 Hz, 4000 to 6500 Hz, and 8000 to 9500 Hz.

TABLE 9
Summary of Sound Intensity Reduction

| | | | Total Sound | dB Reduction |
|---|---|---|---|---|
| | Additive | | Reduction in | versus |
| Example # | (13 Wt %) | Interlayer | dB | Control |
| C7 | ECOCITE ™ E | None | −40.63 | Control 1^{a} |
| E45 | ECOCITE ™ E | 1 | −44.05 | −3.41 |
| E46 | ECOCITE ™ E | 2 | −45.80 | −5.16 |
| E47 | ECOCITE ™ E | 3 | −45.76 | −5.13 |
| C8 | ECOCITE ™ G | None | −42.50 | Control 2^{b} |
| E48 | ECOCITE ™ G | 1 | −44.25 | −1.75 |
| E49 | ECOCITE ™ G | 2 | −46.27 | −3.76 |
| E50 | ECOCITE ™ G | 3 | −46.60 | −4.09 |
| C9 | ECOCITE ™ H | None | −41.85 | Control 3^{c} |
| E51 | ECOCITE ™ H | 1 | −44.92 | −3.06 |
| E52 | ECOCITE ™ H | 2 | −45.79 | −3.94 |
| E53 | ECOCITE ™ H | 3 | −46.19 | −4.34 |
| C10 | T-mix | None | −40.96 | Control 4^{d} |
| E54 | T-mix | 1 | −43.72 | −2.76 |
| E55 | T-mix | 2 | −45.90 | −4.94 |
| E56 | T-mix | 3 | −45.58 | −4.62 |

^{a}Control sample for E45 to E47.
^{b}Control sample for E48 to E50.
^{c}Control sample for E51 to E53.
^{d}Control sample for E54 to E56.

Example 57 is a trilayer laminate of stiff (<30 pph plasticizer) PVB sandwiched between two sheets of Glass-filled Nylon 6 with added Ecocite™ H (13 wt %). C11 is two sheets of glass-filled Nylon 6 sheet with Ecocite™ H, not laminated.

Example 58 is similar to E57 except that the Nylon 6 is not glass-filled, and the Ecocite™ is included at a level of 30 wt %. C12 is similar to C11 except that Nylon 6 is not glass-filled.

A pin was projected at each target from a load cell in a tower at a predetermined velocity. The energy required to penetrate the target was measured and recorded in Table 10. The percent increase for each example of the invention was determined by subtracting the total impact of the comparative example from the total impact of the example, and dividing the difference by the total impact of the comparative example, then multiplying by 100%.

TABLE 10

| | Max Load | Impact | Velocity | Total | Increase |
|---|---|---|---|---|---|
| Example | (J) | (J) | (m/sec) | (J) | (%) |
| C11 | 6.6 | 119.3 | 2.3 | 25.7 | — |
| E57 | 11.7 | 118.8 | 2.2 | 39.9 | 55.1 |
| C12 | 66.2 | 118.9 | 2.3 | 112.5 | — |
| E58 | 91.4 | 118.6 | 2.3 | 125.2 | 11.3 |

1. A thermoplastic polyamide composition having enhanced surface adhesion properties, comprising: the reaction product of a silane coupling compound with a blend of a polyamide with at least one other thermoplastic or elastomeric polymer as toughener.

2. The polyamide composition of claim 1 wherein the composition comprises: (a) from about 5 to about 30 weight percent of a free-flowing toughener comprising from about 20 weight percent to about 95 weight percent polyvinyl butyral; (b) complimentally, 95 to 25 weight percent polyamide that is melt processible below about 320° C. and a number average molecular weight of at least 5,000; (c) a coupling agent; and (d) optionally, filler in an amount of up to about 45 weight percent.

3. The composition of claim 2 wherein the toughener comprises one or more polymers having anhydride functionality and one or more polymers having carboxylic acid functionality.

4. The composition of claim 2 wherein the toughener further comprises a non-reactive polymer selected from the group consisting of polyethylene, polypropylene, polyvinylchloride, nylon, olefinic copolymers, and mixtures thereof.

5. The composition of claim 3 wherein the composition comprises a filler in an amount of from about 1 wt % to about 45 wt %, based on the total weight of the composition.

6. The composition of claim 5 wherein the filler is glass filler is present in amount of from about 1 wt % to about 45 wt %.

7. The composition of claim 1 wherein the coupling agent is an aminosilane compound and is included in an amount of from about 0.1 to about 1 wt %.

8. The composition of claim 7 wherein the polyamide is selected from the group consisting of: Nylon 6; Nylon 66; Nylon 69; Nylon 610; and Nylon 612; Nylon 11; Nylon 12; Nylon 12, 12; and copolymers of epsilon-caprolactam with hexamethylenediamine and adipic acid.

9. An article prepared from the composition of claim 1.

10. The article of claim 9 wherein the article is a laminate formed from at least one PVB sheet and at least one adjacent polyamide sheet obtained from the composition of claim 1, wherein the compressive shear strength of the laminate is at least 950.

11. The laminate of claim 10 wherein the laminate comprises a polyamide/polymer/polyamide laminate structure, wherein the polymer is selected from the group consisting of PVB, polyurethane, polyvinylchloride, polycarbonate, polyacrylate, or other polyamides.

12. The laminate of claim 11 wherein the laminate has sound damping properties.

13. An article comprising a laminate of claim 12.

14. The article of claim 10 wherein the article is: a boat; a car; a train; an airplane; a roof; a wall; a building; a tool.

15. The article of claim 9 wherein the article is a laminate comprising at least one layer of a thermoplastic elastomer laminated to the polyamide composition.

16. The article of claim 15 wherein the article is a button or switch on: electronic equipment or an electronic device, a stereo, a compact disc player, a telephone, a television, a remote control, a computer, a keypad, or a touch-screen.

17. A laminate article comprising a laminate structure of polyamide/PVB/polyamide wherein the polyamide is a thermoplastic polyamide composition comprising: (a) from about 5 to about 30 weight percent of a free-flowing toughener comprising from about 20 weight percent to about 95 weight percent polyvinyl butyral; (b) complimentally, 95 to 25 weight percent polyamide that is melt processible below about 320° C. and a number average molecular weight of at least 5,000; (c) optionally a coupling agent in an amount of up to about 1 wt %; and (d) optionally, a filler in an amount of up to about 45 weight percent.

18. An article comprising a laminate of claim 17.

19. The article of claim 18 wherein the article is: a boat; a car; a train; an airplane; a roof; a wall; a building; a wall; a ceiling; a floor; a tool; an appliance.

20. The article of claim 9 wherein the article is formed by an injection molding or a press molding process.

21. A process for increasing the adhesion of a polyamide composition comprising the step of including a silane coupling agent.

22. The process of claim 21 wherein the coupling agent is applied to the surface of the polyamide composition.

23. The process of claim 22 wherein the coupling agent is applied as an aqueous solution at a pH of less than 7.
